(19) United States
(12) Patent Application Publication
(10) Pub. No.: US 2011/0117847 A1
(43) Pub. Date: May 19, 2011

(54) ELECTRONIC APPARATUS AND COMMUNICATION CONTROL METHOD

(75) Inventor: Hideyuki Nakagawa, Koganei-shi (JP)

(73) Assignee: KABUSHIKI KAISHA TOSHIBA, Tokyo (JP)

(21) Appl. No.: 12/949,344

(22) Filed: Nov. 18, 2010

(30) Foreign Application Priority Data
Nov. 19, 2009 (JP) 2009-264229

(51) Int. Cl. H04B 7/00

(52) U.S. Cl. 455/41.2

(57) ABSTRACT

According to one embodiment, a communication module executes close proximity wireless transfer. A connection control module establishes a connection between the communication module and an external device which are in a close proximity state when the communication module is in an unconnected state, and releases the connection when a period in which a response from the external device is absent exceeds a connection time-out value. A communication control module executes a service by close proximity wireless transfer. A detection module detects a start and a stop of the service. A change module changes the connection time-out value in response to detection of the start and the stop of the service, in such a manner that the connection time-out value during a period in which the service is being executed is greater than the connection time-out value during a period in which the service is not executed.

### CROSS-REFERENCE TO RELATED APPLICATIONS

This application is based upon and claims the benefit of priority from Japanese Patent Application No. 2009-264229, filed Nov. 19, 2009; the entire contents of which are incorporated herein by reference.

### FIELD

Embodiments described herein relate generally to an electronic apparatus which executes close proximity wireless transfer, and a communication control method which is applied to this electronic apparatus.

### BACKGROUND

In recent years, in IC cards, mobile phones, etc., wireless communication such as near field communication (NFC) has begun to be used. A user can easily execute communication for an authentication process, an accounting process, etc., simply by performing an operation of holding the IC card or mobile phone over a reader/writer module of a host apparatus.

Recently, a novel close proximity wireless transfer technology, which enables communication at high speed, has begun to be developed. In this novel close proximity wireless transfer technology, not only authentication and accounting services can be performed between the devices, but also large-capacity data files of text data, video data and audio data can be exchanged between the devices.

Jpn. PCT National Publication No. 2009-506619 discloses a method of finding a time-out parameter in a communication session of, e.g. NFC. In this method, use is made of a time-out value for determining whether a physical connection is released, and a time-out value for recovering the released connection. The latter time-out value is calculated, based on a through-put between the devices.

In the meantime, in the close proximity wireless transfer, a connection is established between devices by bringing the devices close together, and a desired service is started. In addition, if the devices are separated away from each other, the connection between the devices is released. In this case, what needs to be noted is a connection time-out value which is used by a lower level layer (e.g. a physical layer or a data link layer) in order to determine the release of connection between the devices.

If the connection time-out value is set at a large value, the release of connection occurs less possibly due to a displacement in position between the devices for which a service is being provided (i.e. the tolerance to displacement is high). On the other hand, however, even if the devices are separated away from each other, the connection between the devices is not immediately released. In other words, for a while after the devices are separated away from each other by user to a distance greater than the range of communication, it is possible that the devices are recognized as if these devices were kept in the connected state. In this case, for example, even if the user brings a device, which has been separated away from a certain device, close to another device within the range of communication (hereinafter this operation is referred to as “touch”), it is possible that a connection is not immediately established between the touched devices. Thus, if the connection time-out value is set at a large value, the operability may possibly deteriorate.

Conversely, if the connection time-out value is set at a small value, the connection between devices is immediately released when these devices are separated away from each other. Accordingly, the user can immediately perform the next operation, such as an operation of touching a device, which has been separated away from a certain device, close to another device and starting communication between the devices, and therefore the operability is high. On the other hand, however, the release of connection tends to easily occur due to a displacement in position between the devices for which a service is being provided (i.e. the tolerance to displacement is low).

### BRIEF DESCRIPTION OF THE DRAWINGS

A general architecture that implements the various feature of the embodiments will now be described with reference to the drawings. The drawings and the associated descriptions are provided to illustrate the embodiments and not to limit the scope of the invention.

FIG. 1 is an exemplary block diagram illustrating the connection between an electronic apparatus according to an embodiment and an external device;

FIG. 2 is an exemplary timing chart illustrating a variation of a connection time-out value which is used in the electronic apparatus of the embodiment;

FIG. 3 is an exemplary view for explaining connection time-out based on the connection time-out value which is used in the electronic apparatus of the embodiment;

FIG. 4 is an exemplary block diagram illustrating an example of the system configuration of the electronic apparatus of the embodiment;

FIG. 5 is an exemplary perspective view showing the external appearance of the electronic apparatus of the embodiment;

FIG. 6 is an exemplary view illustrating an example of close proximity wireless transfer which is executed between the electronic apparatus of the embodiment and an external device;

FIG. 7 illustrates an example of a software architecture for controlling close proximity wireless transfer, which is applied to the electronic apparatus of the embodiment;

FIG. 8 is an exemplary flow chart illustrating the procedure of a process which is executed by the electronic apparatus of the embodiment when a service is started; and

FIG. 9 is an exemplary flow chart illustrating the procedure of a process which is executed by the electronic apparatus of the embodiment when a service is stopped.

### DETAILED DESCRIPTION

Various embodiments will be described hereinafter with reference to the accompanying drawings.

In general, according to one embodiment, an electronic apparatus comprises a communication module, a connection control module, a communication control module, a detection module and a change module. The communication module is configured to execute close proximity wireless transfer. The connection control module is configured to establish a connection between the communication module and an external device which are in a close proximity state when the communication module is in an unconnected state, and is configured to release the connection when a period in which a response from the external device is absent exceeds a connection time-out value. The communication control module is configured to execute a service by close proximity wireless transfer between the communication module and the external device when the connection is established. The detection module is configured to detect a start and a stop of the service. The change module is configured to change the connection time-out value in response to detection of the start and the stop of the service, in such a manner that the connection time-out value during a period in which the service is being executed is greater than the connection time-out value during a period in which the service is not executed.

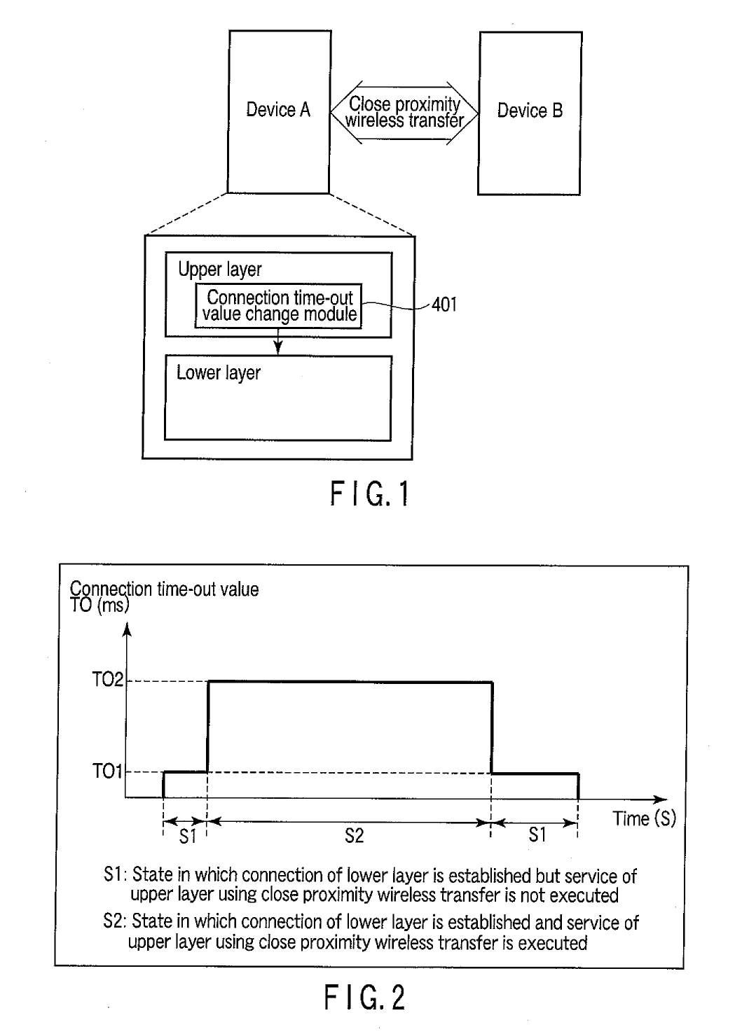

FIG. 1 shows the structure of an electronic apparatus according to an embodiment. The electronic apparatus is realized, for example, as a mobile apparatus (e.g. a mobile phone, a PDA, an audio player, etc.), a personal computer, or a consumer apparatus (e.g. a TV, a video recorder, etc.). This electronic apparatus includes a communication module which executes close proximity wireless transfer. The electronic apparatus establishes a wireless connection to another device (external device) having a close proximity wireless function, and executes close proximity wireless transfer with the external device in a peer-to-peer format. A device A in FIG. 1 corresponds to the electronic apparatus of the embodiment, and a device B in FIG. 1 corresponds to the external device having the same function as the electronic apparatus of the embodiment. The devices A and B are in a peer-to-peer relationship.

Communication control programs, which provide a protocol stack for controlling the close proximity wireless transfer of the device A, are generally classified into a lower layer and an upper layer. The lower layer controls the (physical) connection between the device A and device B which are in a close proximity state. To be more specific, when the device A (the communication module in the device A) is in the unconnected state, the lower layer executes a process of establishing a connection between the device A and device B which are in the close proximity state. Further, using the connection time-out value, the lower layer detects that the close proximity state between the device A and device B has been released, that is, the device A and device B have been separated away from each other to a distance outside the range of communication. In other words, the lower layer determines whether a time period in which a response from the device B is absent is greater than the connection time-out value. If the time period of the absence of a response from the device B is greater than the connection time-out value, the lower layer releases the connection between the device A and device B and informs the upper layer of the release of the connection.

The upper layer executes a service such as data transfer, by using the connection (communication path) established by the lower layer. Specifically, when a connection is established between the device A (the communication module in the device A) and the device B, the upper layer executes a service such as data transfer, by close proximity wireless transfer between the device A (the communication module in the device A) and the device B.

As has been described above, if the connection time-out value which is used in the lower layer is set at a large value, the tolerance to displacement during the execution of a service is improved. However, even if the devices are separated away from each other, the connection between the devices is not immediately released, and the operability may possibly deteriorate. Conversely, if the connection time-out value is set at a small value, the operability is improved, but the tolerance to displacement decreases while a service is being provided. As a result, such a situation possibly occurs that the release of connection tends to easily occur while the service, such as transfer of a data file, is being provided.

In the present embodiment, the upper layer includes a connection time-out value change module 401 in order to obtain an adequate operability without lowering the tolerance to displacement during the provision of a service. The connection time-out value change module 401 dynamically varies the connection time-out value which is used in the lower layer, according to whether a service is being provided by the upper layer or not. To be more specific, the connection time-out value change module 401 sets the connection time-out value at a high value while a service is being provided by the upper layer, and sets the connection time-out value at a low value during a period other than the period in which the service is being provided by the upper layer. Thereby, the tolerance to displacement during the provision of a service can be increased, and the operability can be improved.

FIG. 2 illustrates the variation of a connection time-out value TO in relation to the state transition of the device A. In FIG. 2, the horizontal axis indicates time, and the vertical axis indicates the connection time-out value TO. The states of the device A are generally classified into an unconnected state in which a connection between the communication module and the external device is not established, and a connected state in which a connection between the communication module and the external device is established. In the connected state, the device A is set in either a state S1 or a state S2. The state S1 is a “state in which the connection of the lower layer is established but the service of the upper layer using close proximity wireless transfer is not executed”. The state S1 includes a state from the establishment of the connection between the devices to the start of the service, and a state from the stop of the service to the release of the connection between the devices. The state S2 is a “state in which the connection of the lower layer is established and the service of the upper layer using close proximity wireless transfer is executed”. In other words, the state S2 is a state from the start of the service to the stop of the service. The stop of the service means, for example, that the execution of the protocol or application used in the execution of the service, is stopped. In many cases, after the service is completed, messages for stopping the service are exchanged between the device A and device B, and thereby the service is stopped. Needless to say, the end or completion of the service may be treated as the stop of the service.

As the close proximity wireless transfer, TransferJet™, for instance, is usable. In this case, the lower layer may be mapped in the CNL (CoNnection Layer) of TransferJet™, the services of the upper layer may be mapped in the services using the protocols controlled by the PCL (Protocol Conversion Layer) of TransferJet™. As described above, in the close proximity wireless transfer, the connection time-out value causes a relationship of trade-off between the usability and the tolerance to displacement during the provision of the service.

In the present embodiment, as shown in FIG. 2, the connection time-out value change module 401 sets the connection time-out value TO at a small value (TO1) in the period (state S1) other than the period of the service provision, thereby to improve the usability, and sets the connection time-out value at a large value TO2 in the period of the service provision (state S2), thereby to increase the tolerance to displacement. Specifically, the connection time-out value change module 401 changes the connection time-out value TO from TO1 to TO2, immediately before the start of the service. If the service is stopped, the connection time-out value change module 401 changes the connection time-out value TO from TO2 to TO1.

Even after the service is stopped, the device A is kept in the connected state, until the close proximity state between the device A and device B is released, that is, until the connection between the device A and device B is released. When the connection between the device A and device B has been released, a transition is made from the connected state to the unconnected state. If the device A transitions to the unconnected state, the device A can establish a new connection with a device which is in close proximity to the device A. Similarly, when the connection between the device A and device B has been released, the device B transitions to the unconnected state. If the device B transitions to the unconnected state, the device B can establish a new connection with a device which is in close proximity to the device B.

The value of the connection time-out value TO2 which is used during the execution of the service may be varied in accordance with the kind of the service which is executed by the upper layer. During the time period from the establishment of the connection between the devices A and B to the start of the service, the upper layer executes a negotiation with the device B and determines the service which is to be provided by the close proximity wireless transfer between the devices A and B. Examples of the service which can be provided include a push service which transmits a predetermined data file from a local device (device A) to an external device (device B) by using OBEX, and a storage service which mounts a part or all of a file system of the external device (device B) on a mount point of a file system of the local device (device A) by using SCSI. Usually, there is a case in which the influence of the release of connection during data transfer is higher in the storage service using SCSI, than in the service (push service) using OBEX. Thus, while the storage service using SCSI is being provided, the connection time-out value may be controlled so that the tolerance to displacement may become higher than in the period in which the push service using OBEX is used.

In this case, for example, if the service determined by the negotiation is the push service using OBEX, the upper layer of the device A changes the connection time-out value TO from TO1 to TO2-1, and starts the determined service. If the service is stopped, the upper layer of the device A restores the connection time-out value TO to TO1. On the other hand, if the service determined by the negotiation is the storage service using SCSI, the upper layer of the device A changes the connection time-out value TO from TO1 to TO2-2, and starts the determined service. If the service is stopped, the upper layer of the device A restores the connection time-out value TO to TO1.

The connection time-out values T01, TO2-1 and TO2-2 have the following relationship:

TO1<TO2-1<TO2-2.

In the meantime, as the value of the connection time-out value TO2 which is used during service, use may be made of a value associated with the protocol (OBEX, SCSI, other general-purpose protocol) which is used in order to execute the determined service, instead of the value which is associated with the determined service. For example, the above-described connection time-out value 102-1 may be associated with the OBEX protocol, and the connection time-out value TO2-2 may be associated with the SCSI protocol. In this case, if the protocol, which is used for the execution of the service determined by the negotiation, is OBEX, the upper layer of the device A changes the connection time-out value TO from TO1 to TO2-1, and starts the determined service. On the other hand, if the protocol, which is used for the execution of the service determined by the negotiation, is SCSI, the upper layer of the device A changes the connection time-out value TO from TO1 to TO2-2, and starts the determined service.

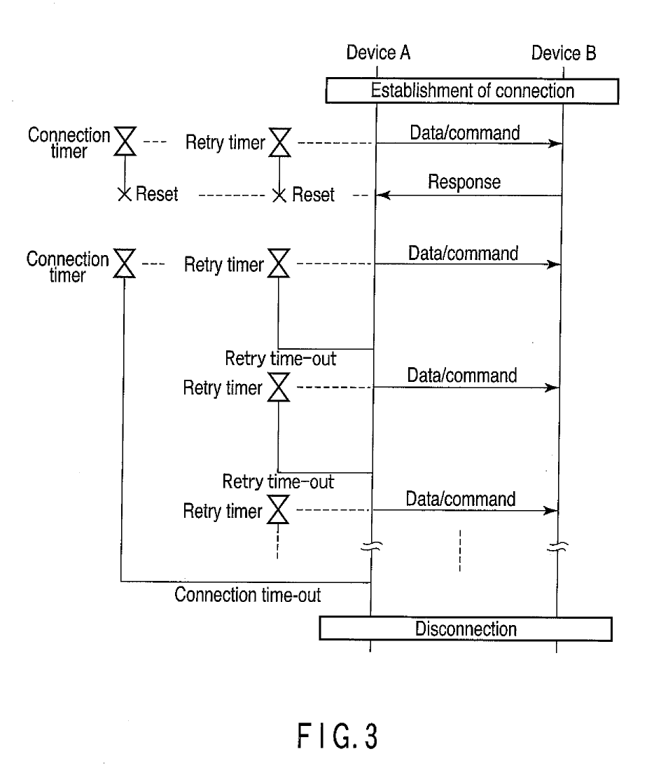

Next, referring to FIG. 3, a description is given of an example of the operation for detecting the release of the close proximity state by using the connection time-out value.

When a connection between the device A and device B is established, the device A transitions to a connected state. During the period of the connected state, the lower layer of the device A counts the time in which close proximity wireless transfer between the device A and device B is interrupted, that is, the time in which a response from the device B is absent, and determines whether the counted time exceeds the connection time-out value.

If the counted time exceeds the connection time-out value, the lower layer detects the occurrence of connection time-out, that is, the release of the close proximity state between the device A and device B. Then, the lower layer cooperates with the upper layer to release the connection between the device A and device B.

The lower layer may use, for example, two timers, namely, a retry timer and a connection timer. Each time data or a command is wirelessly transferred to the device B, the lower layer starts each of the retry timer and connection timer. The retry timer is a timer which is used in order to determine whether or not to re-transmit a message (data or command). If a response from the device B is received within the time period indicated by a retry time-out value from the transmission of the message, the values of the retry timer and connection timer are reset.

On the other hand, if no response from the device B is received within the time period indicated by the retry time-out value from the transmission of the message, retry time-out occurs and the message is re-transmitted, and the retry timer is restarted. The connection timer continues to count the time in which no response is received from the device B. The device A is kept in the connected state until the time in which no response is received exceeds the connection time-out value. If no response is received from the device B, despite the message being re-transmitted several times, and as a result the time in which no response is received from the device B exceeds the connection time-out value, connection time-out occurs and the connection between the device A and device B is released (“disconnection”).

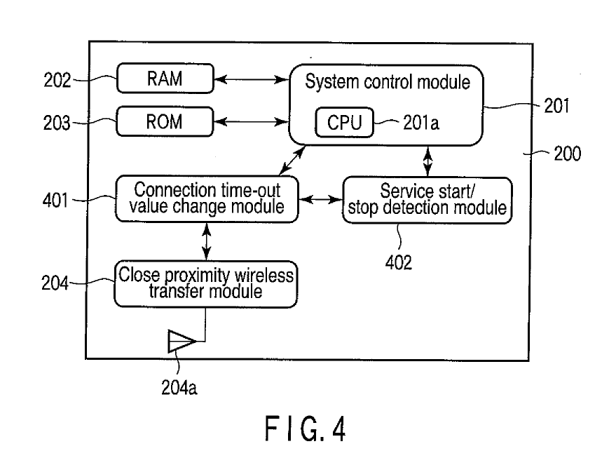

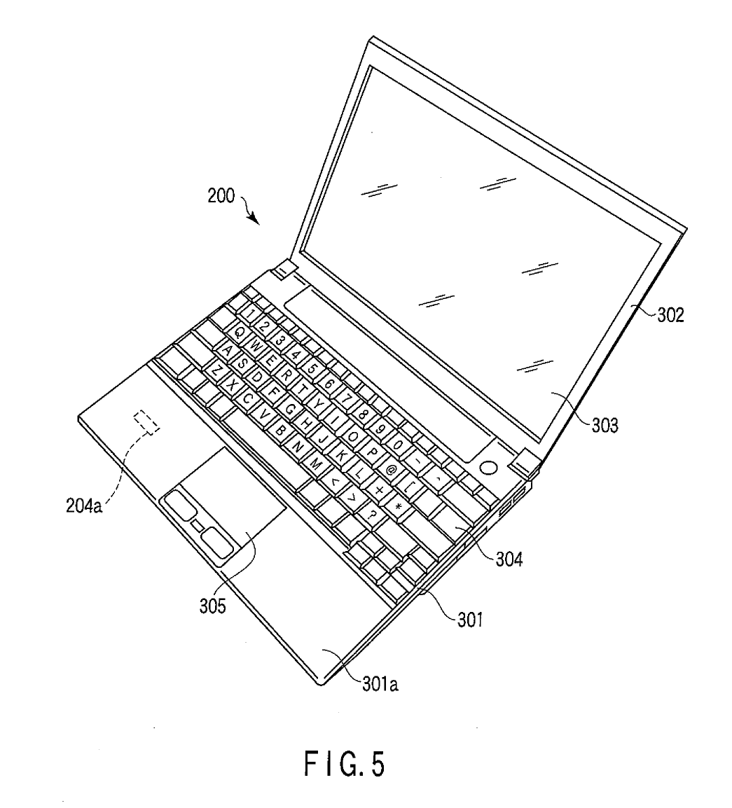

Next, referring to FIG. 4, an example of the system configuration of the electronic apparatus of the embodiment is described.

The electronic apparatus 200 includes a system control module 201, a RAM 202, a ROM 203, and a close proximity wireless transfer module 204. The electronic apparatus 200 further includes a service start/stop detection module 402 and the above-described connection time-out value change module 401.

The system control module 201 controls the operations of the respective components in the electronic apparatus 200. The system control module 201 includes a CPU 201a. The CPU 201a is a processor which executes various programs stored in the ROM 203. The RAM 202 is a memory which stores data being processed and a stack. The ROM 203 is a memory which stores various application programs and a communication control program for controlling close proximity wireless transfer of the close proximity wireless transfer module 204. The CPU 201a executes the communication control program stored in the ROM 203, thereby controlling the close proximity wireless transfer module 204.

The close proximity wireless transfer module 204 is a communication module which executes close proximity wireless transfer. The close proximity wireless transfer module 204 can communicate with another device (external device) having a close proximity wireless transfer function, which is present within a predetermined range of communication from the close proximity wireless transfer module 204. The wireless communication between the close proximity wireless transfer module 204 and the external device is enabled only when the close proximity wireless transfer module 204 and the external device are in the close proximity state, that is, only when the distance between the close proximity wireless transfer module 204 and the external device is within the range of communication (e.g. 3 cm). When the close proximity wireless transfer module 204 and the external device are brought close together within the range of communication, the communication between the close proximity wireless transfer module 204 and the external device is enabled. Then, the operation of establishing a connection (wireless connection) between the close proximity wireless transfer module 204 and the external device is started. After the connection (wireless connection) between the devices is established, a service, such as data transfer using SCSI, OBEX or other general-purpose protocol, is executed by the close proximity wireless transfer between the close proximity wireless transfer module 204 and the external device.

In the close proximity wireless transfer, an induction electric field is used. As a close proximity wireless transfer method, TransferJet™, for instance, can be used. TransferJet™ is a close proximity wireless transfer method which uses UWB, and high-speed data transfer can be realized.

The close proximity wireless transfer device 204 is connected to an antenna 204a. The antenna 204a is an electrode called “coupler”, and executes data transmission/reception to/from the external device by a radio signal using an induction electric field/magnetic field. When the external device comes near within the range of communication (e.g. 3 cm) from the antenna 204a, the antennas (couplers) of the close proximity wireless transfer device 204 and the external device are coupled by the induction electric field/magnetic field, and thereby wireless communication between the close proximity wireless transfer device 204 and the external device is enabled. In the meantime, the close proximity wireless transfer device 204 and the antenna 204a can be realized as a single module.

The service start/stop detection module 402 detects the start and stop of a service which is provided by the upper layer after the connection between the close proximity wireless transfer device 204 and the external device is established. For example, the service start/stop detection module 402 may detect the start and stop of the protocol, which is used for executing the service, as the start and stop of the service. The connection time-out value change module 401 varies the above-described connection time-out value which is used by the lower layer. For example, responding to the detection of the start of the service and the detection of the stop of the service, the connection time-out value change module 401 varies the connection time-out value which is used by the lower layer, so that the connection time-out value during the period in which the service is executed may become greater than the connection time-out value during the period in which the service is not executed.

Next, referring to FIG. 5, a description is given of an example of the external appearance of the electronic apparatus 200, assuming the case in which the electronic apparatus 200 is realized as a portable personal computer.

FIG. 5 is a perspective view showing the external appearance of the electronic apparatus 200. The electronic apparatus 200 comprises a main body 301 and a display unit 302. The display unit 302 is attached to the main body 301 such that the display unit 302 is rotatable between an open position where the top surface of the main body 301 is exposed, and a closed position where the top surface of the main body 301 is covered by the display unit 302. A display 303 such as an LCD is provided in the display unit 302.

The main body 301 has a thin box-shaped housing. A keyboard 304 and a touch pad 305 are disposed on the top surface of the housing of the main body 301.

The top surface of the main body 301, to be more specific, a part of a palm rest area 301a on the top surface of the main body 301, functions as a communication surface. Specifically, the close proximity wireless transfer module 204 and antenna (coupler) 204b are provided within the main body 301 so as to be opposed to the palm rest area 301a on the top surface of the main body 301. The antenna (coupler) 204a is disposed so as to output a radio signal (induction electric field) to the outside via the top surface of the main body 301 (specifically, a part of the palm rest area 301a on the top surface of the main body 301). A small area on the top surface of the main body 301, which is opposed to the antenna (coupler) 204b, that is, a small area on the top surface of the main body 301, which is located on the upper side of the antenna (coupler) 204a, is used as a communication position.

The user can start a service, such as data transfer between the external device and the electronic apparatus 200, by performing, for example, an operation (“touch operation”) of holding the external device, which has the close proximity wireless transfer function, over the communication position in the palm rest area 301a of the main body 301.

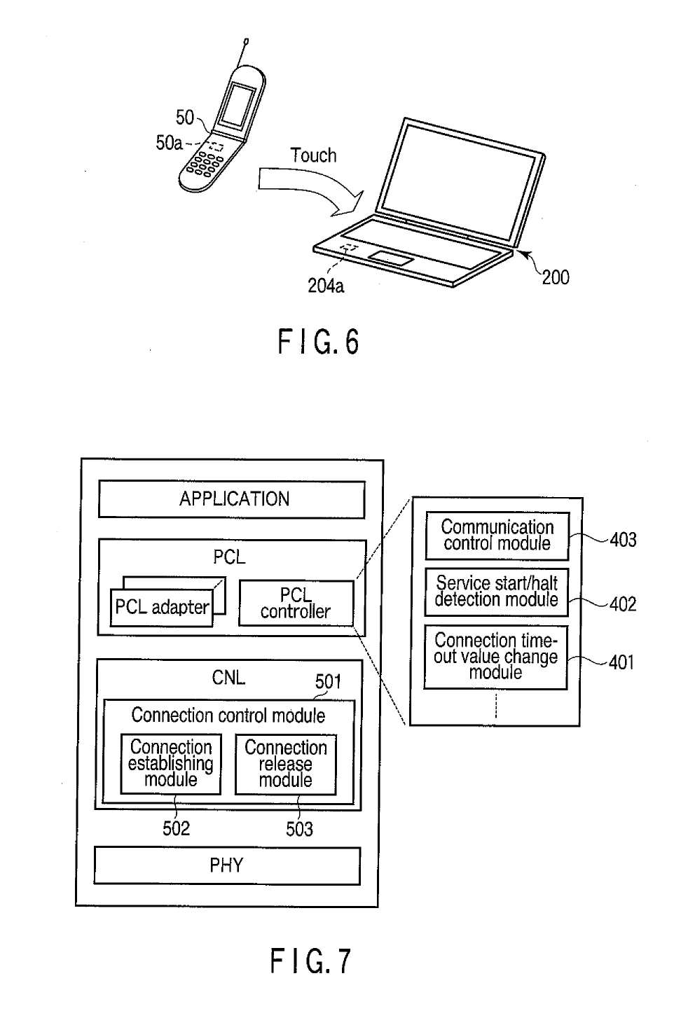

FIG. 6 illustrates close proximity wireless transfer which is executed between a mobile phone 50 and the electronic apparatus 200. An antenna (coupler) for close proximity wireless transfer is provided within the housing of the mobile phone 50 so as to be opposed to the back surface of the housing. In this case, close proximity wireless transfer between the mobile phone 50 and electronic apparatus 200 can be started by bringing the back surface of the housing of the mobile phone 50 over the communication position on the palm rest area of the main body 301 of the electronic apparatus 200 (or by placing the mobile phone 50 on the palm rest area).

Next, referring to FIG. 7, a description is given of a software architecture for controlling close proximity wireless transfer which is executed with use of the close proximity wireless transfer module 204. The case is assumed in which the communication control function of the embodiment is applied to the protocol stack of TransferJet™. As shown in FIG. 7, the protocol stack for controlling close proximity wireless transfer may comprise a physical layer (PHY), a connection layer (CNL), a protocol conversion layer (PCL), and an application layer.

The physical layer (PHY) is a layer which controls physical data transfer, and corresponds to a physical layer in an OSI reference model. A part or all of the functions of the physical layer (PHY) may also be realized by using hardware in the close proximity wireless transfer module 204.

The physical layer (PHY) converts data from the connection layer (CNL) to a radio signal. The connection layer (CNL) corresponds to a data link layer through a transport layer in the OSI reference model, and executes data communication by controlling the physical layer (PHY). The connection layer (CNL) may be realized by a part of the above-described communication control program.

The connection layer (CNL) is a layer which controls a (physical) connection (CNL connection) between the close proximity wireless transfer module 204 and the external device, which are set in a close proximity state. The connection layer (CNL) is used as the above-described lower layer. The function of a connection control module 501 is mapped in the connection layer (CNL). The connection control module 501 establishes a connection between the close proximity wireless transfer module 204 and the external device which are in a close proximity state when the close proximity wireless transfer module 204 is in an unconnected state, and releases the connection between the close proximity wireless transfer module 204 and the external device when the period in which no response is received from the external device exceeds the connection time-out value TO. The connection control module 501 includes a connection establishing module 502 and a connection release module 503.

During the period in which the close proximity wireless transfer module 204 is in the unconnected state, the connection establishing module 502 executes a process of transmitting the above-described connection request signal in order to detect an external device which is in close proximity to the close proximity wireless transfer module 204, or a process of receiving from the external device a connection accept signal indicative of acceptance in response to the transmitted connection request signal or receiving a connection request signal from the external device. When the connection control module 501 receives the connection accept signal or connection request signal from the external device, the connection control module 501, in cooperation with, e.g. the PCL layer, establishes the connection (CNL connection) between the close proximity wireless transfer module 204 and the external device. If the connection between the close proximity wireless transfer module 204 and the external device is established, the close proximity wireless transfer module 204 is set in the connected state. During the period in which the close proximity wireless transfer module 204 is in the connected state, the connection release module 503 counts a time in which no response is received from the external device. If the counted time exceeds the connection time-out value, the connection release module 503 releases the connection between the close proximity wireless transfer module 204 and the external device.

The protocol conversion layer (PCL) corresponds to a session layer in the OSI reference model, and is positioned between the application layer and the connection layer (CNL). The protocol conversion layer (PCL) corresponds to the above-described upper layer and may be realized by the above-described communication control program. In order to establish the connection between the two devices, the protocol conversion layer (PCL) executes control of each application (communication program) in the application layer, and executes control of the connection layer (CNL).

To be more specific, the protocol conversion layer (PCL) includes a plurality of communication adapters (PCL adapters) corresponding to a plurality of kinds of application protocols (e.g. SCSI, OBEX, other general-purpose protocol, etc.), and a PCL controller which controls the operation of the protocol conversion layer (PCL). The PCL controller includes, as functions, a communication control module 403 and the above-described connection time-out value change module 401 and service start/stop detection module 402. When the connection between the close proximity wireless transfer module 204 and the external device is established, the communication control module 403 executes a negotiation with the external device and determines a service which is to be provided by the close proximity wireless transfer between the close proximity wireless transfer module 204 and the external device. Then, the communication control module 403 starts the determined service. In this case, the communication control module 403 executes, for example a process of starting one of the communication adapters (PCL adapters), which corresponds to the protocol (e.g. SCSI, OBEX, other general-purpose protocol, etc.) corresponding to the determined service. The started PCL adapter converts the data (user data) of the application program, which corresponds to this PCL adapter, to a specific transmission data format which can be handled by the connection layer (CNL). By this conversion process, data, which is transmitted/received by any one of the communication programs, is converted to packets (data of a specific transmission data format) which can be handled by the connection layer (CNL). In the present embodiment, for example, immediately before the start of the service, the connection time-out value is changed from TO1 to TO2.

If the service is completed, the communication control module 403 stops the service. In this case, for example, a process of stopping the active PCL adapter is performed. Further, in the embodiment, when the service is stopped, the connection time-out value is changed from TO2 to TO1.

A description is now given of an example of the state transition of the communication control module 403 of the PCL controller. The communication control module 403 transitions to one of three states, namely, an unconnected state, a connecting state and a connected state. The unconnected state is a state in which the devices are yet to be brought close together, or in other words a state in which no connection is established between the close proximity wireless transfer module 204 and any one of external devices. When the close proximity wireless transfer module 204 has received a connection request signal or a connection accept signal from the external device, the communication control module 403 transitions to the connecting state. The connecting state is a state in which a CNL connection is being established by the CNL layer. When the establishment of the CNL connection has been completed, the communication control module 403 transitions to the connected state.

In the connected state, the communication control module 403 starts a control sequence comprising three phases, namely, an authentication phase, a negotiation phase and a service execution phase. To start with, the communication control module 403 authenticates a communication-counterpart device in the authentication phase. If the authentication is successfully executed, the communication control module 403 transitions to the negotiation phase. In the negotiation phase, the communication control module 403 executes a negotiation with the communication-counterpart device, and determines a service which is to be provided. If the negotiation is successfully executed, the communication control module 403 transitions to the service execution phase. The communication control module 403 executes the service, which is determined by the negotiation, in the service execution phase. If the service is completed, the communication control module 403 stops the service. Even when the service is stopped, the state of the communication control module 403 is kept in the connected state. If connection time-out occurs in the connected state, the connection (CNL connection) between the devices is released (disconnection), and the state of the communication control module 403 is transitioned to the unconnected state.

By the transition of the state of the communication control module 403 to the unconnected state, a new CNL connection can be established. In the present embodiment, when the service is stopped, the connection time-out value is changed from TO2 to T01. Thus, connection time-out occurs as soon as the devices are separated by the user to a distance which is outside the range of communication. Thereby, the connection between the devices can immediately be released.

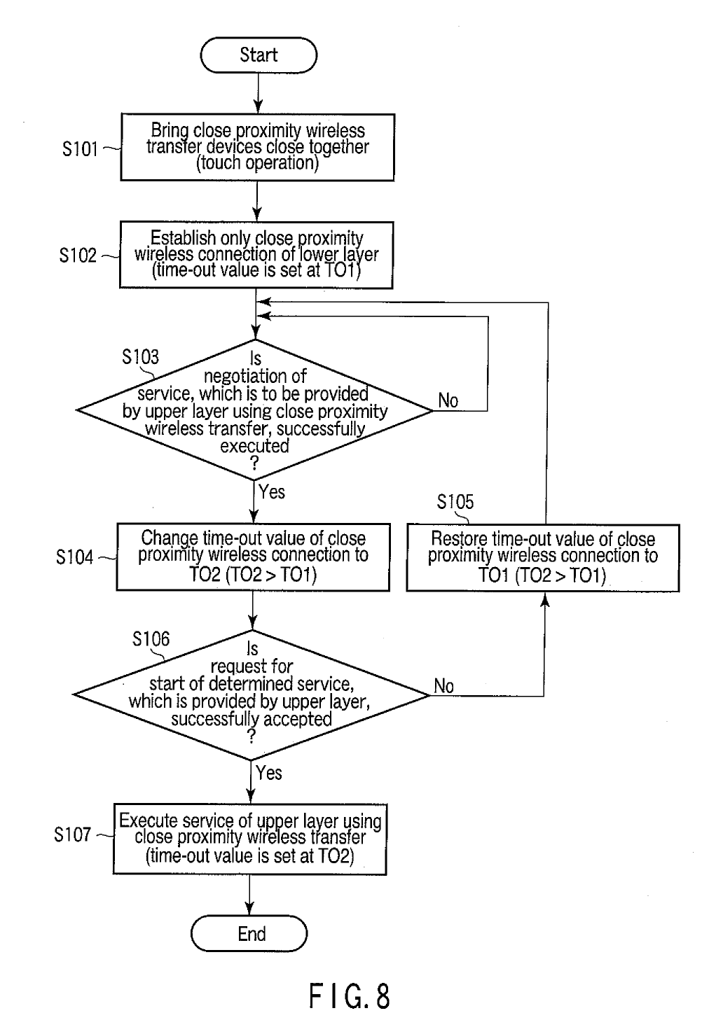

Next, referring to a flow chart of FIG. 8, a description is given of the procedure of a communication control process at the time of the start of a service, which is executed by the communication control program.

Under the control of the communication control program, the lower layer (CNL) starts a process of transmitting a connection request signal in order to detect an external device which is in close proximity to the electronic apparatus 200 (close proximity wireless transfer module 204) or a process of receiving a connection request signal from the external device. The process of transmitting a connection request signal or the process of receiving a connection request signal from the external device is executed while the close proximity wireless transfer module 204 is in the unconnected state. If the user executes a touch operation of bringing the electronic apparatus 200 and external device close together (step S101), the lower layer can receive a connection accept signal indicative of acceptance in response to a connection request signal transmitted by the electronic apparatus 200, or receive a connection request signal from the external device. When the connection accept signal or connection request signal is received from the external device, the lower layer establishes, under the control of the communication control program, a connection between the close proximity wireless transfer module 204 and the external device (step S102). Thereby, the state of the PCL controller is transitioned from the unconnected state to the connecting state. At this time, the connection time-out value TO, which is used in the lower layer, is a default value T01.

The upper layer (PCL controller) executes a negotiation with the external device in order to determine a service which is to be provided (step S103). If the negotiation is successfully executed, the PCL controller changes the connection time-out value TO from TO1 to TO2 (step S104). As the value of TO2, use may be made of a value associated with the determined service, or a value associated with the protocol which is used in order to execute the determined service.

Subsequently, the upper layer requests the external device to start the determined service (step S106). In step S106, for example, the upper layer transmits to the external device a service start message including service information indicating the determined service (the protocol that is used, the application that is used). If the service start request is successfully accepted, that is, if a response indicative of the acceptance of the service start message is received from the external device (YES in step S106), the upper layer starts the determined service (step S107). In step S107, the upper layer starts the protocol (PCL adapter) corresponding to the determined service. In the meantime, in step S106, the upper layer may be thought that the upper layer reports in the service start message that the connection time-out value TO is changed to TO2. In this case, the service start message may include a changed connection time-out value TO2. The external device changes the connection time-out value TO to a designated value, only when the service start request is accepted.

On the other hand, if the service start request fails to be accepted (NO in step S106), the upper layer changes the connection time-out value TO of the lower layer from TO2 to TO1 (step S105). Then, the upper layer advances to the process of step S103.

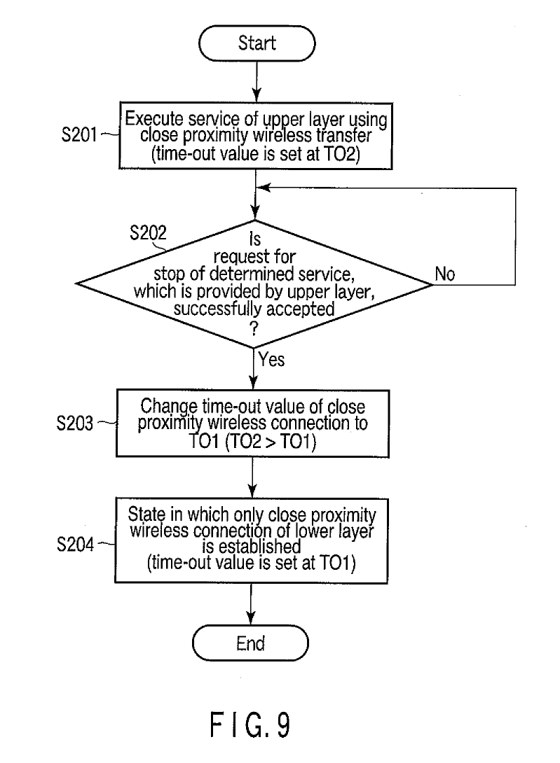

Next, referring to a flow chart of FIG. 9, a description is given of the procedure of a communication control process at the time of the stop of a service, which is executed by the communication control program.

Assume now the state in which a service is being executed by close proximity wireless transfer between the electronic apparatus 200 and the external device (step S201). At this time, the connection time-out value TO of the lower layer is set at TO2, since the service is being provided. If the service is completed, the upper layer requests the external device to stop the service (step S202). In step S202, for example, the upper layer transmits to the external device a service stop message requesting the stop of the service. If the service stop request is successfully accepted, that is, if a response indicative of the acceptance of the service stop message is received from the external device (YES in step S202), the upper layer stops the service and changes the connection time-out value TO from TO2 to TO1 (step S203). In the process of stopping the service, for example, a process of stopping the active protocol (active PCL adapter) is executed. In step S202, it may be thought that the upper layer reports in the service stop message that the connection time-out value TO is changed to TO1. The external device changes the connection time-out value TO to a designated value, only when the service stop request is accepted.

Thereafter, the state of the upper layer transitions to a state in which only the connection (CNL connection) of the lower layer is established, and no service is executed (step S204). At this time, since the connection time-out value TO is set at TO1, the lower layer determines, based on the connection time-out value 101, the presence/absence of the occurrence of connection time-out, that is, the presence/absence of the release of the close proximity state between the devices.

As has been described above, in the embodiment, the connection time-out value, which is used by the lower layer in order to determine the presence/absence of the release of the close proximity state between the devices, is varied according to whether the service is being provided by the upper layer. To be more specific, in the embodiment, a large connection time-out value is used while the service is being provided by the upper layer, and a connection time-out value, which is smaller than the connection time-out value that is used while the service is being provided by the upper layer, is used during a time period other than the period in which the service is being provided by the upper layer. Thereby, the tolerance to displacement during the period in which the service is being provided can be increased, and a quick shift can be made to the next action during the period other than the period in which the service is being provided, and therefore the operability can be improved.

In the meantime, recommended values of the connection time-out values TO1 and TO2, which are used by the devices each having the close proximity wireless communication function may be determined in advance. The states of the two devices, which are in the connected state, are synchronized. Thus, even without executing a process of exchanging between the devices the connection time-out values that are used, it is possible to match the connection time-out values which are used by the two connected devices.

In the embodiment, the case has been described in which the connection time-out value which is used before the start of the service is identical to the connection time-out value which is used after the stop of the service. However, the connection time-out value which is used before the start of the service is not necessarily identical to the connection time-out value which is used after the stop of the service. For example, the connection time-out value which is used after the stop of the service may be set to be smaller than the connection time-out value which is used before the start of the service.

The functions of the communication control program of the embodiment may be realized by hardware modules.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An electronic apparatus comprising:
a communication module configured to execute close proximity wireless transfer;
a connection control module configured to establish a connection between the communication module and an external device when the communication module is in an unconnected state and the communication module and the external device are in a close proximity state, and to release the connection when a period in which a response from the external device is absent exceeds a connection time-out value;
a communication control module configured to execute a service by close proximity wireless transfer between the communication module and the external device when the connection is established;
a detection module configured to detect a start and a stop of the service; and
a change module configured to change the connection time-out value in response to detection of the start and the stop of the service, such that the connection time-out value during a period in which the service is being executed is greater than the connection time-out value during a period in which the service is not executed.

2. The electronic apparatus of claim 1, wherein the detection module is configured to detect a start and a stop of a protocol as the start and the stop of the service, wherein the protocol is used for executing the service.

3. The electronic apparatus of claim 1, wherein
the communication control module is configured to execute a negotiation with the external device in order to determine the service which is to be provided by the close proximity wireless transfer between the communication module and the external device, and
wherein the change module is configured to set the connection time-out value during the period in which the service is being executed to be a value associated with the determined service.

4. The electronic apparatus of claim 1, wherein
the communication control module is configured to execute a negotiation with the external device in order to determine the service which is to be provided by the close proximity wireless transfer between the communication module and the external device, and
wherein the change module is configured to set the connection time-out value during the period in which the service is being executed to be a value associated with a protocol which is used for executing the determined service.

5. An electronic apparatus comprising:
a communication module configured to execute close proximity wireless transfer;
a connection establishing module configured to establish a connection between the communication module and an external device when the communication module is in an unconnected state and the communication module and the external device are in a close proximity state;
a connection release module configured to count a time in which a response from the external device is absent during a period of a connected state in which the connection is established, and to release the connection when the counted time exceeds a connection time-out value; and
a communication control module configured to execute a negotiation with the external device when the connection has been established to determine a service which is to be provided by close proximity wireless transfer between the communication module and the external device, to change, when the service has been determined, the connection time-out value to a value which is greater than the connection time-out value at a time before the service is started, to start the determined service, and to change, when the service has been stopped, the connection time-out value to a value which is smaller than the connection time-out value at a time before the service is stopped.

6. A communication control method of controlling close proximity wireless transfer which is executed by a communication module, the method comprising:
establishing a connection between the communication module and an external device when the communication module is in an unconnected state and the communication module and the external device are in a close proximity state;
counting a time in which a response from the external device is absent during a period of a connected state in which the connection is established, and releasing the connection when the counted time exceeds a connection time-out value;
determining, when the connection has been established, a service which is to be provided by close proximity wireless transfer between the communication module and the external device;
changing, when the service has been determined, the connection time-out value to a value which is greater than the connection time-out value at a time before the service is started;
starting the determined service; and
changing, when the service has been stopped, the connection time-out value to a value which is smaller than the connection time-out value at a time before the service is stopped.

7. The communication control method of claim 6, wherein said changing the connection time-out value to a value which is greater than the connection time-out value at the time before the service is started comprises setting the connection time-out value to a value associated with the determined service.

8. The communication control method of claim 6, wherein said changing the connection time-out value to a value which is greater than the connection time-out value at the time before the service is started comprises setting the connection time-out value to a value associated with a protocol which is used for executing the determined service.
